(19) United States
(12) Patent Application Publication
(10) Pub. No.: US 2026/0203665 A1
(43) Pub. Date: Jul. 16, 2026

(54) METHODS, SYSTEMS AND APPARATUSES FOR COMMUNICATION NETWORK-BASED MACHINE LEARNING

(71) Applicant: HUAWEI TECHNOLOGIES CO., LTD., Shenzhen (CN)

(72) Inventors: Xi CHEN, Shenzhen (CN); Wen TONG, Shenzhen (CN); Amir Hossein ESTIRI, Shenzhen (CN); Yasser KHALIL, Shenzhen (CN); Mahdi BEITOLLAHI, Shenzhen (CA); Hongliang LI, Shenzhen (CN); Guojun ZHANG, Shenzhen (CN); Xu LI, Shenzhen (CN)

(21) Appl. No.: 19/561,838

(22) Filed: Mar. 10, 2026

Related U.S. Application Data
(63) Continuation of application No. PCT/CN2024/071689, filed on Jan. 10, 2024.

(51) Int. Cl. G06N 20/00

(52) U.S. Cl. CPC G06N 20/00

(57) ABSTRACT

Methods and devices are described that enable decentralized, cooperative training of a machine learning model in a communication network, while limiting exposure of sensitive local data. A first node has a local model trained on local data, and receives one or more other models from one or more other nodes in the communication network. The first node performs model aggregation to generate an aggregated model from the received other models. The local model is replaced with the aggregated model and/or the aggregated model is transmitted to at least one other node in the communication network.

### CROSS-REFERENCE TO RELATED APPLICATIONS

The present disclosure is a continuation of PCT application no. PCT/CN2024/071689, filed on January 10, 2024, entitled “METHODS, SYSTEMS AND APPARATUSES FOR COMMUNICATION NETWORK-BASED MACHINE LEARNING”, the disclosure of which is hereby incorporated by reference in its entirety.

### TECHNICAL FIELD

The present disclosure relates to methods, systems and apparatuses for training and deployment of machine learning models, in a decentralized communication network.

### BACKGROUND

Deep learning is a type of machine learning that allows computational models that are composed of multiple processing layers to learn representations of data with multiple levels of abstraction. These methods have dramatically improved the state-of-the-art in speech recognition, visual object recognition, object detection and many other domains such as drug discovery and genomics.

Some existing machine learning systems rely on a centralized server that collects data from multiple sources and uses the collected data to train a machine learning model. However, such systems may be lacking in operational transparency, traceability, reliability, security and/or trusted data provenance features. As well, a centralized system may be vulnerable to the single point of failure problem. Another challenge is that there may be a loss of data privacy in a centralized system. Consumer devices, such as smartphones, may generate large amounts of personal data that may be useful for training a machine learning model. However, it may not be possible for a centralized machine learning system to use this data without violating data privacy. Improvements are therefore needed.

### SUMMARY

In various examples, the present disclosure describes methods, systems and apparatuses that enables decentralized, cooperative training of a machine learning model in a communication network (comprised of multiple nodes in communication with each other), while requiring no exchange of sensitive local data. Unlike some existing distributed learning systems, there is no transmission of any sensitive data outside of a node. In examples described herein, data local to a node may not be shared outside of the node, thus helping to ensure data privacy is maintained. The machine learning model local to each node may be of any architecture, and there may be different model architectures across different nodes. This may be advantageous because it may not be possible or practical for a common model architecture to be optimized for all participating nodes. As well, the trained model parameters may be accessible to and jointly owned by all participating nodes.

Such a decentralized system may avoid drawbacks of existing machine learning systems that rely on a centralized server, for example the single point of failure problem may be avoided as well as the problem of model ownership and fairness. As well, such a system may be flexible and adaptable to resource limitations at different nodes. The system may be easily scaled up or down as nodes join or leave. Examples of the present disclosure may help to overcome drawbacks of existing federated learning systems as well as existing distributed learning systems.

In an example aspect, the present disclosure describes a method at a first node in a communication network, the first node having stored in memory a local model trained on local data, the method including: receiving, from one or more other nodes in the communication network, respective one or more other models represented by respective one or more sets of model parameters; performing model aggregation to generate an aggregated model from the received one or more other models; and performing at least one of: replacing the local model of the first node with the aggregated model; or transmitting the aggregated model to at least one other node in the communication network.

In an example of the preceding example aspect of the method, performing model aggregation may include aggregating the local model of the first node with the received one or more other models to generate the aggregated model.

In an example of the preceding example aspect of the method, the method may include: prior to aggregating the local model of the first node with the received one or more other models, updating the local model using the local data.

In an example of any of the preceding example aspects of the method, two or more other models may be received, and performing model aggregation may further include aggregating the two or more other models to generate the aggregated model.

In an example of any of the preceding example aspects of the method, performing model aggregation may include aggregating different model architectures using knowledge distillation, where the local data of the first node may be used for knowledge distillation.

In an example of some of the preceding example aspects of the method, performing model aggregation may include aggregating identical model architectures using parameter averaging.

In an example of any of the preceding example aspects of the method, the method may include: transmitting a request for at least one of the one or more other models.

In an example of any of the preceding example aspects of the method, at least one of the one or more other models may be received in absence of a request from the first node.

In an example of any of the preceding example aspects of the method, the aggregated model may be transmitted to the at least one other node in the communication network without replacing the local model.

In an example of any of the preceding example aspects of the method, the method may include: transmitting the local model to a same or different at least one other node in the communication network.

In an example of the preceding example aspect of the method, transmitting the local model may be in response to a received request for the local model.

In an example of a preceding example aspect of the method, transmitting the local model may be performed in absence of any received request for the local model.

In an example aspect, the present disclosure describes a computing apparatus include: a processing unit; and a memory including instructions that, when executed by the proceeding unit, cause the apparatus to perform any of the preceding example aspects of the method.

In an example aspect, the present disclosure describes a system comprising a plurality of nodes in communication with each other, wherein each node is independently configured to perform any of the preceding example aspects of the method.

In an example aspect, the present disclosure describes a non-transitory computer readable medium having machine-executable instructions stored thereon, wherein the instructions, when executed by a computing apparatus, cause the apparatus to perform any of the preceding example aspects of the method.

In an example aspect, the present disclosure describes a computing apparatus including: a transmitting module configured to carry out the transmitting steps of any of the preceding example aspects of the method; and a receiving module configured to carry out the receiving steps of any of the preceding example aspects of the method.

In an example aspect, the present disclosure describes a processing module configured to control an apparatus to cause the apparatus to carry out any of the preceding example aspects of the method.

In an example aspect, the present disclosure describes a system chip comprising a processing unit configured to execute instructions to cause an apparatus to carry out any of the preceding example aspects of the method.

In an example aspect, the present disclosure describes a computer program characterized in that, when the computer program is run on a computer, the computer is caused to execute any of the preceding example aspects of the method.

### BRIEF DESCRIPTION OF THE DRAWINGS

Reference will now be made, by way of example, to the accompanying drawings which show example embodiments of the present application, and in which:

FIG. 1 is a block diagram illustrating an example of a communication network, in which examples of the present disclosure may be implemented;

FIG. 2 is a block diagram illustrating an example of a computing apparatus, which may be used to implement examples of the present disclosure;

FIG. 3 is a block diagram illustrating an example implementation of a node, in accordance with examples of the present disclosure;

FIG. 4 is a flowchart illustrating an example method for generating an aggregated model, in accordance with examples of the present disclosure;

FIG. 5 is a flowchart illustrating an example method for transmitting a local model, in accordance with examples of the present disclosure; and

FIG. 6 is a block diagram illustrating an example implementation of a model aggregator, in accordance with examples of the present disclosure.

Similar reference numerals may have been used in different figures to denote similar components.

### DETAILED DESCRIPTION

In various examples, the present disclosure describes methods, systems and apparatuses for training a machine learning-based model, in particular a deep learning model (which may be referred to simply as a “model”). In particular, the present disclosure describes methods, systems and apparatuses for cooperative training of a model by multiple communication nodes (which may be referred to simple as “nodes”) in a communication network. The disclosed methods, systems and apparatuses may be used for decentralized, cooperative training of a model while maintaining data privacy, however in some examples a central node may be used for some operations.

To assist in understanding the present disclosure, federated learning and distributed training (also referred to as distributed learning) are first discussed. Both federated learning and distributed training may be considered techniques for cooperative learning of a machine learning model.

In conventional federated learning, a centralized server receives updates from clients and aggregates the updates to learn a shared global model. Local data stay with the clients and are not shared; thus, data privacy is maintained. However, federated learning typically requires clients to use models with the same architectures. Though some recent developments in federated learning can support models with different architectures, the heterogeneity in the model architectures may be restricted. Further, federated learning generally rely on a centralized server to perform the aggregation. Use of a centralized server may have drawbacks, such as model ownership issues (e.g., clients do not have ownership of the global model even though clients participate in training the global model), single point of failure and/or communication bottlenecks.

In conventional distributed training the workload of training a model is split among multiple mini processors, called worker nodes or slave nodes. Data are typically owned by the master node, and are shared partially to the slave nodes. The master node collects model updates from the slave nodes and uses the updates them to update the master model. In conventional distributed training, the master node collects data from slave nodes and the master node shares the collected data among different slave nodes, thus data privacy is not maintained. As well, distributed training may have drawbacks such as model ownership issues, single point of failure, communication bottlenecks and lack of support for heterogeneity in model architectures in different slave nodes.

In various examples, the present disclosure describes a solution that may help to preserve data privacy, may allow for heterogeneity of model architectures across different participating nodes and/or may enable participating nodes to jointly own the trained models.

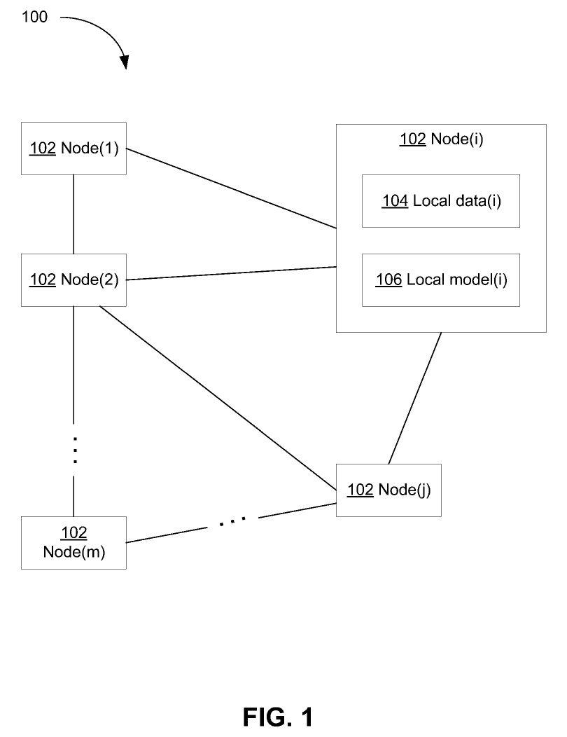

FIG. 1 illustrates an example system 100 that may be used to implement examples of communication network-based deep learning of models (which may be referred to as Net-DL), as disclosed herein. The system 100 has been simplified in this example for ease of understanding; generally, there may be more entities and components in the system 100 than that shown in FIG. 1.

The system 100 includes a plurality of nodes 102 (node(1) 102 to node(m) 102, generally referred to as node 102), each of which stores or has access to respective sets of local data 104 (also referred to as client data). The local data 104 may be used by the respective node 102 to train a respective local model 106. For example, the local data 104 may be divided into a training set, a validation set and a testing set. Generally, in machine learning, a training set refers to a subset of data that is used to train a machine learning model, a validation set refers to another subset of data that is used to evaluate the performance of the machine learning model during training (e.g., to tune the hyperparameters of the model), and a testing set is another subset of data that is used to evaluate the performance of the trained model (e.g., to estimate the generalization error of the trained model). Details of the local data 104 and local model 106 are shown only for only node 102 (specifically node(i) 102), however it should be understood that each node 102 may have (or may have access to) its own local data 104 and its own local model 106. It should be understood that the nodes 102 may alternatively be referred to as clients, user devices, client devices, edge devices, terminals, consumer devices, or electronic devices, among other possibilities. That is, the term “node” is not intended to limit implementation in a particular type of device or in a particular context.

Each node 102 may independently be an end user device, a network device, a private network, or other singular entity (e.g., mobile device, personal computer, etc.) or plural entity (e.g., a local network of devices at an institution) that is able to generate, collect, store or otherwise access local data 104, and that is able to communicate with the system 100 to share a model.

In the case where a node 102 is an end user device or edge device, the node 102 may be or may include such devices as a client device/terminal, user equipment/device (UE), wireless transmit/receive unit (WTRU), mobile station, fixed or mobile subscriber unit, cellular telephone, station (STA), personal digital assistant (PDA), smartphone, laptop, computer, tablet, wireless sensor, wearable device, smart device, machine type communications device, smart (or connected) vehicle, Internet of Things (IoT) device, or consumer electronics device, among other possibilities. In the case where a node 102 is a network device, the node 102 may be or may include a base station (BS) (e.g., eNodeB or gNodeB), router, access point (AP), personal basic service set (PBSS) coordinate point (PCP), among other possibilities. In the case where a node 102 is a private network, the node 102 may be or may include a private network of an institute (e.g., a hospital or financial institute), a retailer or retail platform, a company’s intranet, etc.

In the case where a node 102 is an end user device, the local data 104 at the node 102 may be data that is collected or generated in the course of real-life use by user(s) of the node 102 (e.g., captured images/videos, captured sensor data, captured tracking data, etc.). In the case where a node 102 is a network device, the local data 104 at the node 102 may be data that is collected from other end user devices that are associated with or served by the network device. For example, a node 102 that is a BS may collect data from a plurality of user devices (e.g., tracking data, network usage data, traffic data, etc.) and this may be stored as local data 104 on the BS.

Regardless of the form of the node 102, the data collected and stored by each node 102 as local data 104 may be considered to be private data (e.g., restricted to be used only within a private network if the node 102 is a private network, or is considered to be personal data if the node 102 is an end user device), and it is generally desirable to ensure privacy and security of the local data 104 at each node 102.

Each node 102 is capable of executing a machine learning algorithm to train its local model 104 (i.e., update parameters of the local model 106) using its local data 104. For the purposes of the present disclosure, executing a machine learning algorithm at a node 102 means executing computer-readable instructions of a machine learning algorithm to update parameters of a machine learning model (which may be approximated using a neural network).

Each node 102 communicates one or more other node 102 via any suitable network (e.g., the Internet, a P2P network, a WAN and/or a LAN) and over any suitable communication link (e.g., over sidelink communications). The system 100 thus is a communication network formed by of multiple nodes 102 in communication with each other. Communications between the nodes 102 may be secured (e.g., using suitable encryption and authentication techniques).

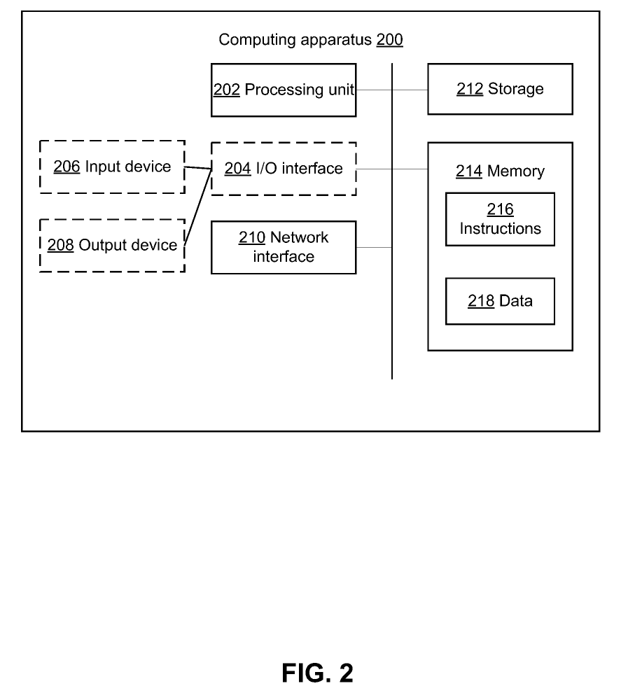

FIG. 2 is a block diagram illustrating a simplified example computing apparatus 200 (which may also be referred to as a computing device or a computing system), which is an example of an apparatus that may be used to implement any of the nodes 102. Other examples suitable for implementing embodiments described in the present disclosure may be used, which may include components different from those discussed below. Although FIG. 2 shows a single instance of each component, there may be multiple instances of each component in the computing apparatus 200.

The computing apparatus 200 may include one or more processing units 202, such as a processor, a microprocessor, a digital signal processor, an application-specific integrated circuit (ASIC), a field-programmable gate array (FPGA), a dedicated logic circuitry, a dedicated artificial intelligence processor unit, a central processing unit (CPU), a tensor processing unit (TPU), a neural processing unit (NPU), a graphics processing unit (GPU), a hardware accelerator, or combinations thereof.

The computing apparatus 200 may also include one or more optional input/output (I/O) interfaces 204, which may enable interfacing with one or more optional input devices 206 and/or optional output devices 208. In the example shown, the input device(s) 206 (e.g., a keyboard, a mouse, a microphone, a touchscreen, and/or a keypad) and output device(s) 208 (e.g., a display, a speaker and/or a printer) are shown as optional components of the computing apparatus 200. In some examples, one or more input device(s) 206 and/or output device(s) 208 may be external to the computing apparatus 200. In other example embodiments, there may not be any input device(s) 206 and output device(s) 208, in which case the I/O interface(s) 204 may not be needed.

The computing apparatus 200 may include one or more network interfaces 210 for wired or wireless communication with other entities of the system 100. For example, the network interface(s) 210 may be used for wired or wireless communication with one or more other nodes 102 in the system 100. The network interface(s) 210 may include wired links (e.g., Ethernet cable) and/or wireless links (e.g., one or more antennas) for intra-network and/or inter-network communications.

The computing apparatus 200 may also include one or more storage units 212, which may include a mass storage unit such as a solid state drive, a hard disk drive, a magnetic disk drive and/or an optical disk drive.

The computing apparatus 200 may include one or more memories 214, which may include a volatile or non-volatile memory (e.g., a flash memory, a random access memory (RAM), and/or a read-only memory (ROM)). The non-transitory memory(ies) 214 may store instructions 216 for execution by the processing unit(s) 202, such as to carry out example embodiments described in the present disclosure. The memory(ies) 214 may include other software instructions, such as for implementing an operating system and other applications/functions. In some example embodiments, the memory(ies) 214 may include software instructions 216 for execution by the processing unit(s) 202 to implement a machine learning algorithm, for example to update parameters of a machine learning model. The memory(ies) 214 may also store data 218, such as values of weights of a neural network (e.g., for the local model 106) and/or the local data 104.

In some example embodiments, the computing apparatus 200 may additionally or alternatively execute instructions from an external memory (e.g., an external drive in wired or wireless communication with the server) or may be provided executable instructions by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. It should be understood that, unless explicitly stated otherwise, references to computer-readable medium in the present disclosure is intended to exclude transitory computer readable medium.

Reference is again made to FIG. 1. The present disclosure describes example methods, systems and apparatuses that enable multiple nodes 102 to collaboratively learn one or more machine learning models (which includes deep learning models) in a decentralized manner. That is, unlike some conventional federated learning or distributed training techniques, there may not be any single central server (or central node) that is always responsible for performing aggregation of updates or for coordinating rounds of training. In examples described herein, any node 102 may communicate model updates with any other node 102, any of the nodes 102 may be an aggregation node that performs model aggregation, and there may be more than one aggregation node at any given time. Nodes 102 may communicate models (e.g., in the form of a set of model parameters) with other nodes 102, however there may not be any sharing of data in order to avoid violating data privacy. There may be synchronized rounds of training carried out in the system 100, or training of models may take place in an asynchronous manner. Different nodes 102 may use different model architectures for the respective local models 106 (e.g., depending on the capabilities and/or computing resources of each node 102).

Each node 102 may independently participate or not participate in the system 100 at any time, meaning the communication network (which includes the participating nodes 102 and the communication links between nodes 102) may be dynamic. There does not need to be any one node 102 (or group of nodes 102) that coordinates communication in the system 100, rather each node 102 may operate independently and may independently select to operate (or to not operate) as an aggregation node at any time. In a special case where there is only one node 102 that acts as an aggregation node, the communication of model parameters may be similar to federated learning, with a difference in that the role of the aggregation node is not fixed to any one node 102 (e.g., even if there is only one aggregation node in the system 100, which node 102 serves as the aggregation node may change over time). Further, examples of the present disclosure may enable model aggregation using model fusion, which may not be supported by conventional federated learning systems.

Some example operations that a node 102 may perform in the role of an aggregation node are now discussed in the context of node(i) 102, which may represent any generic node 102 in the system 100. As illustrated in FIG. 1, node(i) 102 is in direct communication with one or more other nodes 102, such as node(1), node(2) and node(j) (which may be referred to as neighboring nodes or neighbors of node(i) 102). The communication network of the system 100 may be dynamic, meaning that the neighbors of node(i) 102 may change over time.

The node(i) 102, when operating as an aggregation node, may perform at least one, some or all of the following functions. In one function, the node(i) 102 may receive a model (e.g., in the form of a set of model parameters) from another node 102 and route (or pass) the received model to a neighboring node 102. In another function, the node(i) 102 may receive one or more respective models (e.g., in the form of one or more respective sets of model parameters) from respective one or more other nodes, perform model aggregation (e.g., using an aggregation technique as discussed further below) on the received models and transmit the aggregated model to a neighboring node 102. In another function, the node(i) 102 may optionally update its local model 106 using its local data 104 and transmit its local model 106 (with or without updating) to a neighboring node. In another function, the node(i) 102 may receive one or more respective models (e.g., in the form of one or more respective sets of model parameters) from respective one or more other nodes, aggregate (e.g., using an aggregation technique as discussed further below) the received models with its own local model 106 (which may or may not be updated using the local data 104) and transmit the aggregated model to a neighboring node 102.

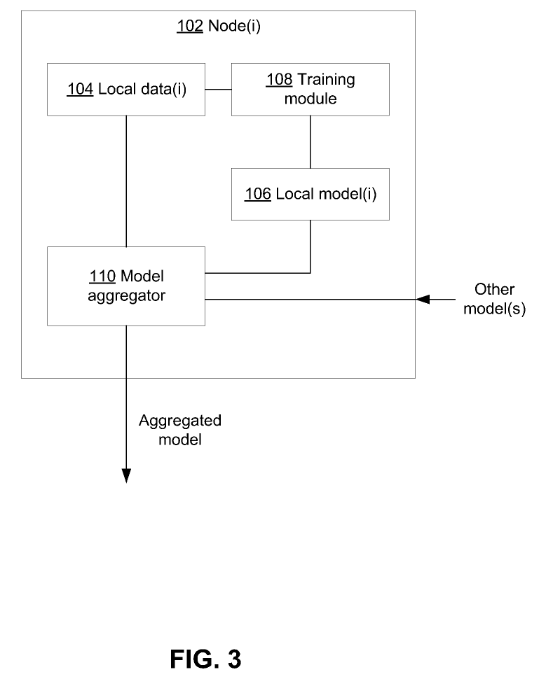

FIG. 3 is a block diagram showing further details of the node(i) 102, which may be used to implement the functions discussed above. It should be understood that the blocks (or software modules) of the node(i) 102 illustrated in FIG. 3 may be embodied as computer executable instructions stored in a memory (e.g., the instructions 216 stored in the memory 214 of the computing apparatus 200 of FIG. 2).

In the example of FIG. 3, the node(i) 102 may store the local data(i) 104 and local model(i) 106 in a memory. The node(i) 102 may also include a training module 108 and a model aggregator 110.

The training module 108 may implement any suitable machine learning algorithm to train (or fine-tune) the local model(i) 106 using the local data(i) 104. The resulting updated local model(i) 106 may be stored locally by the node(i) 102. The local data(i) 104 may be dynamic and time-varying (e.g., new data may be generated by the node(i) 102 being used in normal, everyday operation), thus it may be useful for the local model(i) 106 to be updated over time. For example, the local model(i) 106 may be updated (i.e., trained or fine-tuned) using the local data(i) 104 when triggered by a timer at regular time intervals (e.g., every hour, every day, every week, etc.), when triggered by an aggregation request (e.g., the model aggregator 110 may request that the training module 108 update the local model(i) 106 when the local model(i) 106 is to be included in model aggregation by the model aggregator 110), when triggered by a change in the local data(i) 104 (e.g., the distribution of the local data(i) 104 changes and/or when the amount of local data(i) 104 changes) and/or in response to any other internal or external trigger.

The model aggregator 110 may use any suitable model aggregation (or model fusion) technique (e.g., as discussed further below) to aggregate one or more models. In some examples, the model aggregator 110 may aggregate one or more other received models (received from one or more other nodes 102), and may use the local data(i) 104 to perform the aggregation (e.g., depending on the aggregation technique). In some examples, the local model(i) 106 may be included in performing the aggregation. Optionally, the local model(i) 106 may be updated using the local data(i) 104 prior to performing the aggregation (e.g., the model aggregator 110 may request that the training module 108 update the local model(i) 106 when the local model(i) 106 is to be included in model aggregation by the model aggregator 110). The resulting aggregated model may be transmitted to one or more other nodes 102. In some examples, instead of transmitting the aggregated model to one or more other nodes 102, the node(i) 102 may pass a received model to one or more other nodes 102 (i.e., the received model may bypass the model aggregator 110). The node(i) 102 may or may not replace its local model(i) 106 with the aggregated model.

It should be understood that the neighboring node(s) 102 that transmit other model(s) to the node(i) 102 may or may not be the same as the neighboring node(s) 102 that receive the aggregated model from the node(i) 102. That is, the node(i) 102 may receive another model from a given neighboring node 102 and transmit the aggregated model to the same given neighboring node 102.

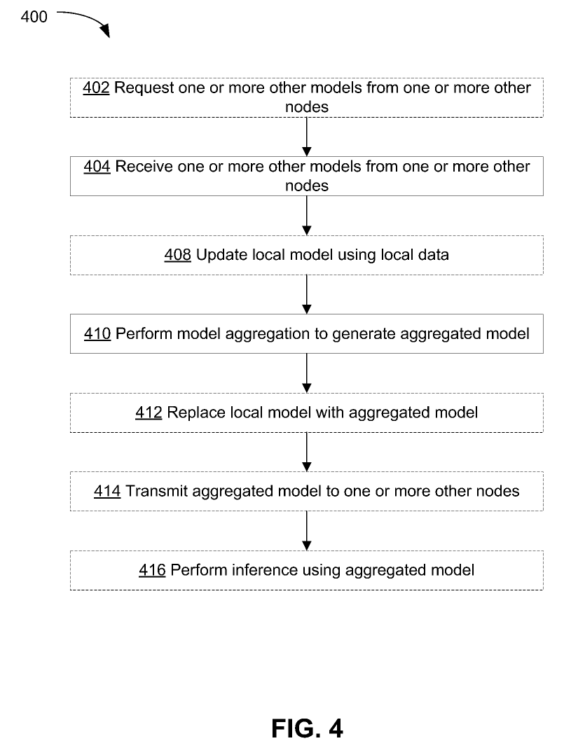

FIG. 4 is a flowchart illustrating an example method 400, which may be performed by any node 102 in the system 100. The method 400 may be performed by a node 102 using the training module 108 and/or the model aggregator 110 as shown in FIG. 3. The method 400 may be performed by a node 102 embodied by a computing apparatus (e.g., the computing apparatus 200 of FIG. 2), in which a processing unit executes instructions to cause the computing apparatus to carry out the steps of the method 400. For ease of understanding, the example method 400 will be described with reference to a first node as the node that is performing the method 400.

Optionally, at 402, the first node may transmit a request for one or more other models from one or more other nodes. In some examples, the request may be a broadcast request, intended to be received by all other participating nodes. In other examples, the request may be transmitted to only the immediate neighboring nodes. In some examples, the request may be intended for specific one or more other nodes and may include an indicator or identifier of the one or more other nodes; if the intended one or more other nodes are not immediate neighboring nodes of the first node, the request may be relayed through other intermediate nodes.

In an example, the request transmitted by the first node may include an indicator or identifier of the first node (e.g., IP address and/or unique identifier of the first node (e.g., UEID or other identifier that uniquely identifies the first node in the system)), an indicator or identifier of the other node(s) that are intended recipients of the request (e.g., IP address and/or unique identifier of the target other node(s)) and optionally a valid time of the request (e.g., a request may only be valid for a defined time period, such as one hour, after which the request may be ignored). In some examples, if the request is not targeted to any particular other node(s) (e.g., the request is a broadcast), the request may not include an indicator or identifier of the other node(s) that are intended recipients of the request. It should be understood that there may be various information included with the request, and the above examples are not intended to be limiting.

The first node may send multiple requests at step 402 (e.g., where each request is intended for a respective different other node) or may send one request (e.g., a single broadcasted or groupcasted request). In some examples, step 402 may be omitted and the first node may receive other model(s) at step 404 in absence of transmitting any request for other model(s).

At 404, one or more other models are received from one or more other nodes. The other model(s) may be received in response to a request transmitted at optional step 402. Each other model may be received in the form of a set of model parameters (and optionally other model information, such as model version number, model size, etc.), thus step 404 may involve receiving one or more sets of model parameters representing one or more other models. In some examples, a received model may be received directly from the other node that is the source of the other model. For example, node(i) may receive model(j) from node(j) and may receive model (m) from node(m). In some examples, a received model may be received via another node that is not the source of the other model. For example, node(i) may receive model(m) from node(j) (e.g., node(m) may serve as a relay or routing node because there is no direct communication link between node(i) and node(m)).

In an example, each of the other model(s) may be received as a reply to the optional request transmitted at step 402. The reply may include an indicator or identifier of the other node that is the source of the other model (e.g., IP address and/or unique identifier of the other node), optionally an indicator or identifier of the first node (e.g., IP address and/or unique identifier of the first node) which may enable the reply to be corrected routed to the first node, as well as model information including the set of model parameters (and optionally other model information such as the model version, model size, etc.). In some examples, if the other model is received without a prior transmission of a request for the model (e.g., if step 402 is omitted), the other model may be received in a broadcast or groupcast. The broadcast or groupcast communication may include an indicator or identifier of the other node that is the source of the other model (e.g., IP address and/or unique identifier of the other node) and model information including the set of model parameters (and optionally other model information such as the model version, model size, etc.). It should be understood that there may be various information included with the communication of the other model, and the above examples are not intended to be limiting.

In some examples, step 404 may be performed by the first node in absence of step 402. For example, all nodes in the system may be configured to broadcast their respective models to all other nodes at regular time intervals (e.g., hourly, daily, weekly, etc.). The first node may thus listen for and receive a broadcasted other model from another node in the system in absence of a request for a model.

The first node may, at 404, receive other model(s) in response to request(s) transmitted at step 402 and may also receive other model(s) that have not be requested.

The first node may perform step 404 to receive other model(s) until a trigger event, after which the method 400 may proceed to step 406. For example, the first node may receive other model(s) and store each received other model in a local memory (e.g., in a model buffer) until a predefined number of other models have been received. In some examples, the first node may receive and store other model(s) in a local memory until a timer (which may be reset to zero at the end of each iteration of the method 400, or which may be started at zero when the first node receives the first other model) reaches a predefined time period. The timer may, in some examples, be synchronized with other nodes in the system. In some examples, the method may proceed to step 406 after the first node receives the other model(s) that were requested at optional step 402 (there may be a timeout event that causes the method to proceed to step 406 if at least one other model is received, even if other requested model(s) have not been received; if no model is received after the timeout event, the method 400 may return to step 402). Other trigger events may be suitable. In some examples, the method 400 may proceed to step 406 after step 404, without any trigger event.

Optionally, at 408, the first node may update its local model using its local data (that is, update the parameters of the local model by training the local model using data sampled from the local data). For example, as shown in FIG. 3, the model aggregator 110 may request the training module 108 to update the local model 106 prior to performing model aggregation. In some examples, the local model may be updated any time prior to model aggregation (e.g., the local model may be regularly or routinely updated by the training module 108) and updating of the local model may occur independently of the method 400.

At 410, model aggregation is performed (e.g., using the model aggregator 110 of FIG. 3) to generate an aggregated model. The aggregated model may be generated using any suitable model aggregation technique, including the model aggregation techniques disclosed herein. In some examples, model aggregation may also be referred to as model fusion.

As will be discussed further below, model aggregation may aggregate only the received other model(s), may aggregate the received other model(s) using the first node’s local data, may aggregate the received other model(s) with the first node’s local model, or may aggregate the received other model(s) with the first node’s local model using the first node’s local data, among other possibilities.

Regardless of how model aggregation is performed, the result is an aggregated model having a set of model parameters that is the result of aggregating multiple sets of model parameters. The aggregated model may have an architecture (e.g., number of model parameters, number of model layers, etc.) that is the same as the architecture of the first node’s local model or that is different from the architecture of the first node’s local model.

Optionally, at 412, the local model at the first node may be replaced with the aggregated model generated at step 410. If the local model has the same architecture as the aggregated model, replacing the local model with the aggregated model may be performed by replacing the set of model parameters of the local model with the set of model parameters of the aggregated model.

In some examples, the local model may not be replaced with the aggregated model and step 412 may be omitted. For example, the aggregated model may have an architecture that is significantly different (e.g., having a much larger or much smaller number of layers, such as a 10 layer model vs. a 100 layer model; having a much larger or much smaller number of parameters, such as a model with 1000 parameters vs. a model with 100,000 parameters) from the current local model stored by the first node. If the aggregated model has an architecture that is significantly different from the current local model, this may indicate that the aggregated model is not suitable for the functions and/or capabilities of the first node.

Optionally, at 414, the aggregated model may be transmitted by the first node to one or more other nodes. The aggregated model may be transmitted as a set of model parameters representing the aggregated model. The first node may transmit the aggregated model to one of the other nodes from which the first node received one other model at step 404 and/or to any other node (e.g., to all immediate neighboring nodes, broadcasted to all nodes in the system, etc.). In some examples, the aggregated model may not be transmitted outside of the first node and step 414 may be omitted.

In some examples, the aggregated model may be transmitted in a communication that includes other information, such as an indicator or identifier of the first node (e.g., IP address and/or unique identifier of the first node) as the source of the aggregated model, optionally an indicator or identifier of one or more other nodes that are intended recipients of the aggregated model (e.g., IP address and/or unique identifier of the other node(s)), as well as model information for the aggregated model including the set of model parameters (and optionally other model information such as the model version, model size, etc.).

It should be noted that the method 400 may include only step 412, may include only step 414, or may include both step 412 and step 414. In some examples, the aggregated model may be stored as a new local model in addition to the existing local model, such that the first node may have multiple local models (e.g., using multiple local models to perform the same task to help improve performance or robustness). In some examples, the aggregated model generated in one iteration of the method 400 may be stored without replacing the existing local model. Instead, the generated aggregated model may be used to fine-tune the existing local model in a subsequent iteration (e.g., when another aggregation is performed).

The first node may then clear its local memory (e.g., model buffer) of any received models.

Optionally, at 416, the first node may use the aggregated model to perform inference. For example, if the aggregated model has replaced the local model, then the aggregated model (which is the new local model) may perform inference on new data collected by the first node.

It should be understood that the method 400 may be performed repeatedly, such that the first node repeated performs model aggregation and updating of its local model (and possibly replacing its local model with a newly generated aggregated model). In this way, the first node may collaborate with other nodes of the system to help ensure the local model used by the first node to perform inference is up-to-date (which may improve accuracy and performance).

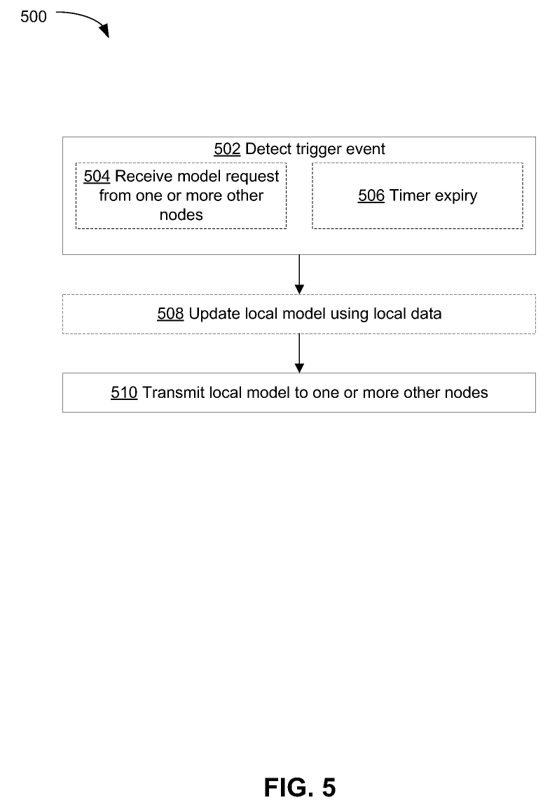

FIG. 5 is a flowchart illustrating an example method 500, which may be performed by any node 102 in the system 100. The method 500 may be performed by a node 102 embodied by a computing apparatus (e.g., the computing apparatus 200 of FIG. 2), in which a processing unit executes instructions to cause the computing apparatus to carry out the steps of the method 500. For ease of understanding, the example method 500 will be described with reference to a first node as the node that is performing the method 500.

At 502, a trigger event is detected. For example, at 504, detecting the trigger event may involve the first node receiving a model request (i.e., a request for a model) from one or more other nodes. The model request may be received directly from the requesting node, or may be received via an intermediate node (e.g., the requesting node may not have a direct communication link with the first node). In another example, at 506, detecting the trigger event may involve expiry of a timer. For example, the first node may maintain a timer that is reset to zero at the end of each iteration of the method 500. In some examples, the timer may be synchronized with other nodes in the system.

Optionally, at 508, the first node may update its local model using its local data (that is, update the parameters of the local model by training the local model using data sampled from the local data). For example, as shown in FIG. 3, the training module 108 may update the local model 106 prior to transmitting the local model 106. In some examples, the local model may be updated any time prior to transmitting the local model (e.g., the local model may be regularly or routinely updated by the training module 108) and updating of the local model may occur independently of the method 500.

At 510, the local model is transmitted to one or more other nodes. The local model may be transmitted as a set of model parameters representing the local model. If a model request was received at step 504, the local model may be transmitted to the requesting node(s). Additionally or alternatively, the local model may be transmitted (e.g., via broadcast or groupcast) to any other nodes such as the immediate neighbors of the first node or all nodes of the system.

In some examples, the local model may be transmitted in a communication that includes other information, such as an indicator or identifier of the first node (e.g., IP address and/or unique identifier of the first node) as the source of the local model, optionally an indicator or identifier of one or more other nodes that are intended recipients of the local model (e.g., IP address and/or unique identifier of the other node(s)), as well as model information for the aggregated model including the set of model parameters (and optionally other model information such as the model version, model size, etc.).

It should be appreciated that the method 400 or the method 500 may be performed by any node 102 in the system 100 of FIG. 1. Thus, any of the nodes 102 may perform model aggregation and may take on the role of aggregation node, independently of any other node 102 in the system 100. Similarly, any of the nodes 102 may share their local model with other nodes, independently of any other node 102 in the system. One or more nodes 102 in the system 100 may perform the method 400 in parallel at any given time, one or more nodes 102 may perform the method 500 in parallel at any given time, and one or more nodes 102 may perform the method 400 while one or more other nodes 102 may perform the method 500 at any given time, in a synchronous manner or asynchronous manner. For example, the nodes 102 may be synchronized through the use of a system-wide clock, for example so that the nodes 102 perform the method 500 and the method 400 in a synchronized manner. In other examples, there may not be synchronization among the nodes 102 and each node 102 may perform the method 400 and/or the method 500 at their own timing.

In some examples, the nodes 102 in the system 100 may be all configured to respond to the same or similar trigger events. For example, the system 100 may be synchronized such that all nodes 102 are configured to perform model transmission (e.g., using the method 500) and model aggregation (e.g., using the method 400) based on a synchronized timer. In another example, all nodes 102 may be configured to request other model(s) in a timer-driven manner and model transmission is performed in response to received request(s). In another example, all nodes 102 may be configured to perform model transmission in a timer-driven manner and model aggregation may be performed in response to receipt of other model(s). It should be understood that different variations in implementation may be possible within the scope of the present disclosure.

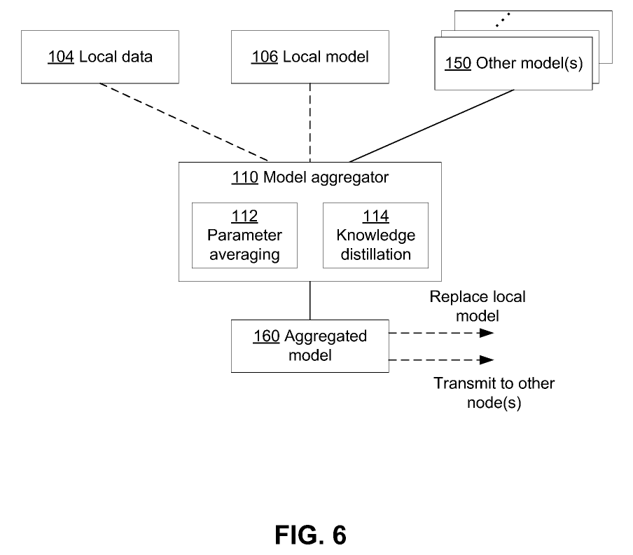

Reference is now made to FIG. 6, illustrating example operations that may be performed by the model aggregator 110, for example at step 410 of method 400. For ease of understanding, FIG. 6 will be described as being performed by the model aggregator 110 of the first node, where the local data 104 and local model 106 are local to the first node, and the other model(s) 150 are model(s) received from other nodes that are not the first node.

As shown, the model aggregator 110 may aggregate at least the other model(s) 150 to generate the aggregated model 160. Optionally, the model aggregator 110 may include the local model 106 with the other model(s) 150 to generate the aggregated model 160. In some examples, depending on the method of aggregation, the model aggregator 110 may optionally use the local data 104 to generate the aggregated model 160. The aggregated model 160 may optionally be used to replace the current local model 106 and/or may optionally be transmitted to one or more other node(s).

The model aggregator 110 may implement any suitable model aggregation techniques. In this example, the model aggregator 110 may include a parameter averaging sub-module 112 (which may be used to perform model aggregation using parameter averaging) and a knowledge distillation sub-module 114 (which may be used to perform model aggregation using knowledge distillation). The model aggregator 110 may include other sub-modules for performing other model aggregation techniques, as appropriate.

Parameter averaging may be used when the models to be aggregated have the same architecture (e.g., same number of parameters and same number of layers). The parameter averaging may be performed using a simple average calculation, similar to the averaging performed in conventional FedAvg algorithms. For example, a suitable approach for parameter averaging is described in McMachan et al. “Communication-efficient learning of deep networks from decentralized data” Artificial intelligence and statistics. PMLR, 2017, the entirety of which is hereby incorporated by reference. In some examples, the parameter averaging may be performed using weighted averaging (e.g., the local model 106 of the first node may be assigned a larger weight value than other model(s) 150 from other node(s)). The local data 104 may not be used for generating the aggregated model 160 using parameter averaging.

In examples where the models to be aggregated have different architectures (e.g., different numbers of parameters and/or different numbers of layers), knowledge distillation may be used to perform model aggregation. Knowledge distillation is based on reducing the distillation loss, which is the difference in the logits generated by the models. A suitable approach for knowledge distillation is described in Hinton et al. “Distilling the knowledge in a neural network” arXiv preprint arXiv:1503.02531 (2015), the entirety of which is hereby incorporated by reference. For example, the local data 104 of the first node may be forward propagated through the models to be aggregated (which may or may not include the local model 106), in order to generate logits (e.g., outputs of the penultimate layer of each model) in order to compute the distillation loss. The distillation loss across the models is minimized in order to generate the aggregated model 160 using knowledge distillation.

It should be understood that the model aggregator 110 may be capable of performing any operations described as optional. For example, the model aggregator 110 may switch between including the local model 106 or not including the local model 106 in the model aggregation; or the model aggregator 110 may switch between using the local data 104 or not using the local data 104 to perform the model aggregation. The selection of how model aggregation is performed may depend on the similarity or difference between the local model 106 and the other model(s) 150 to be aggregated. Additionally, the first node may optionally switch between replacing or not replacing the local model 106 with the aggregated model 160 and/or may switch between transmitting or not transmitting the aggregated model 160 to other node(s).

In various examples, the present disclosure has described methods, systems and apparatuses for collaborative deep learning in a communication network, without reliance on a centralized server. Examples of the present disclosure may be referred to as a “model-follow-data” approach, in which models “flow” freely between nodes in the communication network, without requiring coordination by a centralized server. Any node may perform model aggregation, thus avoiding the drawbacks associated with a centralized server (e.g., communication bottleneck, model ownership issues, single point of failure, etc.). Examples of the present disclosure may support heterogeneity of models, and may enable collaborative learning even when different model architectures are used at different nodes.

Examples of the present disclosure may be implemented in a dynamic communication network, meaning that nodes may joint or leave the network at any time. Each node may independently choose to participate or not participate in the collaborative deep learning at any given time, and may independently choose to act as an aggregation node (e.g., performs model aggregation) or act as a relay node (e.g., simply passes on models without performing model aggregation) at any given time. This may provide greater flexibility and ease of deployment, and may enable a greater variety of devices to participate as nodes.

Examples of the present disclosure may be used to enable improvements in machine learning-based computer vision tasks (e.g., image understanding in various extended reality (XR) applications, visual simultaneous localization and mapping (SLAM), video understanding, scene understanding, etc.), for example. Examples of the present disclosure may enable many devices to collaborate with each other may enable machine learning that benefits from information learned from a larger and more varied dataset (e.g., varied background, varied lighting conditions, varied angles, etc.) while maintaining data privacy and model ownership, and enabling different devices to have use models with different architectures (which may perform better than a common global model).

Examples of the present disclosure may be used to enable improvements in machine learning-based integrated sensing and communications (ISAC). ISAC refers to technologies that combine sensing and communications systems to help utilize wireless resources more efficiently, to enable wide area environment sensing and/or enable mutual benefits. ISAC is of interest for enabling various applications, such as predictive mobile management, autonomous driving, XR applications, etc. Conventional challenges to ISAC include difficulties in collecting a comprehensive dataset by a centralized server, issues around data sharing (e.g., bandwidth limitations, privacy issues), different model architectures being used by different devices, etc. Examples of the present disclosure may be useful to address at least some of these challenges.

Although examples have been described in the context of a communication network formed by multiple nodes (which may each be embodied as a computing apparatus), the present disclosure may also be applicable to any machine learning system having multiple computing entities, such as a multi-core processor, a multi-GPU server, a multi-NPU device, a multi-server cloud system, etc. As well, examples of the present disclosure may be applicable to any network or network-like system, such as smart grids, networks of connective vehicles, networks of monitoring devices (e.g., cameras), sensor networks, data centers, etc.

It should be understood that examples of the present disclosure may be embodied as a method, an apparatus, a non-transitory computer readable medium, a processing module, a chipset, a system chip or a computer program, among others. An apparatus may include a transmitting module configured to carry out transmitting steps described above and a receiving module configured to carry out receiving steps described above. An apparatus may include a processing module, processor or processing unit configured to control or cause the apparatus to carry out examples disclosed herein.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method at a first node in a communication network, the first node having stored in memory a local model trained on local data, the method comprising:
receiving, from one or more other nodes in the communication network, respective one or more other models represented by respective one or more sets of model parameters;
performing model aggregation to generate an aggregated model from the received one or more other models; and
performing at least one of:
replacing the local model of the first node with the aggregated model; or
transmitting the aggregated model to at least one other node in the communication network.

2. The method of claim 1, wherein performing model aggregation comprises aggregating the local model of the first node with the received one or more other models to generate the aggregated model.

3. The method of claim 2, further comprising:
prior to aggregating the local model of the first node with the received one or more other models, updating the local model using the local data.

4. The method of claim 1, wherein two or more other models are received, and wherein performing model aggregation further comprises aggregating the two or more other models to generate the aggregated model.

5. The method of claim 1, wherein performing model aggregation comprises aggregating different model architectures using knowledge distillation, wherein the local data of the first node is used for knowledge distillation.

6. The method of claim 1, wherein performing model aggregation comprises aggregating identical model architectures using parameter averaging.

7. The method of claim 1, further comprising:
transmitting a request for at least one of the one or more other models.

8. The method of claim 1, wherein at least one of the one or more other models is received in absence of a request from the first node.

9. The method of claim 1, wherein the aggregated model is transmitted to the at least one other node in the communication network without replacing the local model.

10. The method of claim 1, further comprising:
transmitting the local model to a same or different at least one other node in the communication network.

11. The method of claim 10, wherein transmitting the local model is in response to a received request for the local model.

12. The method of claim 10, wherein transmitting the local model is performed in absence of any received request for the local model.

13. A computing apparatus, the apparatus being a first node in a communication network, the apparatus comprising:
a processing unit; and
a memory storing a local model trained on local data, the memory including instructions that, when executed by the proceeding unit, cause the apparatus to:
receive, from one or more other nodes in the communication network, respective one or more other models represented by respective one or more sets of model parameters;
perform model aggregation to generate an aggregated model from the received one or more other models; and
perform at least one of:
replacing the local model of the first node with the aggregated model; or
transmitting the aggregated model to at least one other node in the communication network.

14. The apparatus of claim 13, wherein performing model aggregation comprises aggregating the local model of the first node with the received one or more other models to generate the aggregated model.

15. The apparatus of claim 14, wherein the instructions further cause the apparatus to:
prior to aggregating the local model of the first node with the received one or more other models, update the local model using the local data.

16. The apparatus of claim 13, wherein two or more other models are received, and wherein performing model aggregation further comprises aggregating the two or more other models to generate the aggregated model.

17. The apparatus of claim 13, wherein performing model aggregation comprises aggregating different model architectures using knowledge distillation, wherein the local data of the first node is used for knowledge distillation.

18. The apparatus of claim 13, wherein performing model aggregation comprises aggregating identical model architectures using parameter averaging.

19. The apparatus of claim 13, wherein the aggregated model is transmitted to the at least one other node in the communication network without replacing the local model.

20. A non-transitory computer readable medium having machine-executable instructions stored thereon, wherein the instructions, when executed by a computing apparatus that is a first node in a communication network, cause the apparatus to:
receive, from one or more other nodes in the communication network, respective one or more other models represented by respective one or more sets of model parameters;
perform model aggregation to generate an aggregated model from the received one or more other models; and
perform at least one of:
replacing a local model of the first node with the aggregated model; or
transmitting the aggregated model to at least one other node in the communication network.
